(19) United States
(12) Patent Application Publication
(10) Pub. No.: US 2026/0038251 A1
(43) Pub. Date: Feb. 5, 2026

(54) LEARNED IMAGE COMPRESSION BY AI GENERATED CONTENT

(71) Applicant: HUAWEI TECHNOLOGIES CO., LTD., Shenzhen, Guangdong Province (CN)

(72) Inventors: Wei Jiang, Sunnyvale, CA (US); Wei Wang, San Jose, CA (US); Yue Chen, Saratoga, CA (US)

(21) Appl. No.: 19/357,053

(22) Filed: Oct. 13, 2025

Related U.S. Application Data
(63) Continuation of application No. PCT/US2024/023011, filed on Apr. 4, 2024.
(60) Provisional application No. 63/496,285, filed on Apr. 14, 2023.
(60) Provisional application No. 63/506,514, filed on Jun. 6, 2023.

(51) Int. Cl. G06V 10/774; G06T 9/00; G06V 10/62; G06V 10/72; G06V 10/764; G06V 10/77; G06V 10/82

(52) U.S. Cl. CPC G06V 10/7747; G06T 9/002; G06V 10/62; G06V 10/72; G06V 10/764; G06V 10/7715; G06V 10/82

(57) ABSTRACT

A method implemented by a decoder. The method includes receiving a vision-language control latent feature, a vision-language latent feature of an original image, and a diffusion latent feature of the original image, where the vision-language latent feature comprises text and integers; computing, based on the vision-language latent feature, a decoded vision-language feature; computing, based on the vision-language control latent feature and the decoded vision-language feature, an encoded control feature; reconstructing, based on the encoded control feature and the decoded vision-language feature, a baseline image output; computing, based on the diffusion latent feature, the encoded control feature, and the decoded vision-language feature, a supplementary output; and reconstructing, based on the supplementary output and the baseline image output, a final decoded image output.

### CROSS-REFERENCE TO RELATED APPLICATIONS

This application is a continuation of International Patent Application No. PCT/US2024/023011 filed on Apr. 4, 2024, which claims priority to U.S. Provisional Application No. 63/496,285 filed on Apr. 14, 2023 and U.S. Provisional Application No. 63/506,514 filed on Jun. 6, 2023. The disclosures of the aforementioned applications are hereby incorporated by reference in their entireties.

### TECHNICAL FIELD

The present disclosure relates to Learned Image Compression (LIC), and in particular, to LIC by artificial intelligence (AI) generated content (AIGC).

### BACKGROUND

AIGC uses a wide range of image generative models, including generative adversarial networks (GAN), diffusion models, and auto-regressive (AR) models. The goal is to enable fast and accessible high-quality content creation. Various methods have been developed to allow for efficient manipulation of the generated content using different types of inputs, such as using text descriptions and/or spatial/spatiotemporal compositions like sketches or segmentations.

Large-scale pretrained Vision-Language Models (VLM) have reached a milestone in text-to-image generation for AIGC. By training a very large model using very large datasets of captioned images from the internet, a multi-modal language-image pre-training representation like Contrastive Language-Image Pre-training (CLIP) or Bootstrapping Language-Image Pre-training (BLIP) can be successfully learned through self-supervised contrastive learning. The joint embedding space of text and image is robust to image distribution shift, which enables language-guided zero-shot image generation.

### SUMMARY

A first aspect relates to a method implemented by an encoder. The method includes encoding an original image into a vision-language latent feature comprising text and integers; computing a diffusion latent feature, wherein the diffusion latent feature captures fidelity and expressiveness details of the original image; and transmitting the vision-language latent feature and the diffusion latent feature to a decoder.

A second aspect relates to a method implemented by an encoder. The method includes computing, based on a control signal and an original image, a control latent requirement indicating an encoded control requirement; encoding the original image into a vision-language latent feature comprising text and integers; computing a diffusion latent feature, wherein the diffusion latent feature captures fidelity and expressiveness details of the original image; and transmitting the control latent requirement, the vision-language latent feature, and the diffusion latent feature to a decoder.

A third aspect relates to a method implemented by an encoder. The method includes encoding an original image into a vision-language latent feature comprising text and integers; computing, based on a control signal and the original image, a control latent requirement indicating an encoded control requirement; computing, based on the control latent requirement and the vision-language latent feature, a vision-language control latent feature computing a diffusion latent feature, wherein the diffusion latent feature captures fidelity and expressiveness details of the original image; and transmitting the vision-language control latent feature, the vision-language latent feature, and the diffusion latent feature to a decoder.

Optionally, in a first implementation according to any of the preceding aspects or any implementation thereof, wherein computing the control latent requirement comprises: computing, based on the control signal, a text instruction, wherein the text instruction is a text description describing control requirements of the control signal; computing, based on the text instruction, the original image, and the control signal, an input-oriented text instruction and additional input-oriented prompt instruction; and computing, based on the input-oriented text instruction and the additional input-oriented prompt instruction, the control latent requirement.

Optionally, in a second implementation according to any of the preceding aspects or any implementation thereof, wherein computing the vision-language control latent feature comprises: computing, based on the vision-language latent feature, a decoded vision-language latent feature; computing, based on the control latent requirement and the decoded vision-language latent feature, a baseline image output; and computing, based on the baseline image output and the original image, the vision-language control latent feature.

Optionally, in a third implementation according to any of the preceding aspects or any implementation thereof, wherein the original image is a general three-dimensional (3D) tensor with shape w×h×c, where w, h, c are a width, a height, and a number of channels of an image, and wherein encoding the original image into the vision-language latent feature comprises: encoding the original image into a vision feature tensor with shape wₓ×hₓ×d, wherein width wₓ and height hₓ depend on the width and the height of the original image, and wherein d is a number of feature channels; computing a sparse codebook-based latent feature based on the vision feature tensor and a vision codebook, wherein the vision codebook comprises a plurality of codewords, wherein each codeword has d dimension; and computing, based on the original image, a language latent feature comprising text words, wherein the vision-language latent feature is a combination of the sparse codebook-based latent feature and the language latent feature.

Optionally, in a fourth implementation according to any of the preceding aspects or any implementation thereof, wherein encoding the original image into the vision feature tensor comprises dividing, using a visual transformer (ViT), the original image into patches and encode the patches as a sequence.

Optionally, in a fifth implementation according to any of the preceding aspects or any implementation thereof, wherein encoding the original image into the vision feature tensor comprises encoding in a parallel manner, using a convolutional neural network (CNN), the original image as an entire image.

Optionally, in a sixth implementation according to any of the preceding aspects or any implementation thereof, wherein computing the language latent feature comprises generating, using an image grounded text generator (IGTG), text description to the original image to describe a content of the original image.

Optionally, in a seventh implementation according to any of the preceding aspects or any implementation thereof, wherein computing the diffusion latent feature comprises downsampling the original image to smaller resolution images; and encoding the smaller resolution images to obtain the diffusion latent feature.

A fourth aspect relates to a method implemented by a decoder. The method includes receiving a vision-language latent feature of an original image and a diffusion latent feature of the original image, wherein the vision-language latent feature comprises text and integers; computing, based on the vision-language latent feature, a decoded vision-language feature; reconstructing, based on the decoded vision-language feature, a baseline image output; computing, based on the diffusion latent feature and one of the baseline image output or the decoded vision-language feature, a supplementary output; and constructing, based on the supplementary output and the baseline image output, a final decoded image output.

A fifth aspect relates to a method implemented by a decoder. The method includes receiving a control latent requirement, a vision-language latent feature of an original image, and a diffusion latent feature of the original image, wherein the vision-language latent feature comprises text and integers; computing, based on the vision-language latent feature, a decoded vision-language feature; computing, based on the control latent requirement and the decoded vision-language feature, an encoded control feature; reconstructing, based on the encoded control feature and the decoded vision-language feature, a baseline image output; computing, based on the diffusion latent feature and the baseline image output, a supplementary output; and reconstructing, based on the supplementary output and the baseline image output, a final decoded image output.

A sixth aspect relates to a method implemented by a decoder. The method includes receiving a control latent requirement, a vision-language latent feature of an original image, and a diffusion latent feature of the original image, wherein the vision-language latent feature comprises text and integers; computing, based on the vision-language latent feature, a decoded vision-language feature; computing, based on the control latent requirement and the decoded vision-language feature, an encoded control feature; reconstructing, based on the encoded control feature and the decoded vision-language feature, a baseline image output; computing, based on the diffusion latent feature, the encoded control feature, and the decoded vision-language feature, a supplementary output; and reconstructing, based on the supplementary output and the baseline image output, a final decoded image output.

A seventh aspect relates to a method implemented by a decoder. The method includes receiving a vision-language control latent feature, a vision-language latent feature of an original image, and a diffusion latent feature of the original image, wherein the vision-language latent feature comprises text and integers; computing, based on the vision-language latent feature, a decoded vision-language feature; computing, based on the vision-language control latent feature and the decoded vision-language feature, an encoded control feature; reconstructing, based on the encoded control feature and the decoded vision-language feature, a baseline image output; computing, based on the diffusion latent feature and the baseline image output, a supplementary output; and reconstructing, based on the supplementary output and the baseline image output, a final decoded image output.

An eighth aspect relates to a method implemented by a decoder. The method includes receiving a vision-language control latent feature, a vision-language latent feature of an original image, and a diffusion latent feature of the original image, wherein the vision-language latent feature comprises text and integers; computing, based on the vision-language latent feature, a decoded vision-language feature; computing, based on the vision-language control latent feature and the decoded vision-language feature, an encoded control feature; reconstructing, based on the encoded control feature and the decoded vision-language feature, a baseline image output; computing, based on the diffusion latent feature, the encoded control feature, and the decoded vision-language feature, a supplementary output; and reconstructing, based on the supplementary output and the baseline image output, a final decoded image output.

Optionally, in a first implementation according to any of the fourth aspect through eighth aspect, wherein the vision-language latent feature is a combination of a sparse codebook-based latent feature and a language latent feature, wherein the sparse codebook-based latent feature is based on a vision codebook, and wherein computing the decoded vision-language feature comprises: computing, based on the sparse codebook-based latent feature, using the vision codebook, a decoded image embedding feature; computing, based on the language latent feature, a text embedding feature; and combining the text embedding feature and the decoded image embedding feature to obtain the decoded vision-language feature.

Optionally, in a second implementation according to any of the fourth aspect through eighth aspect, or any implementation thereof, wherein computing the supplementary output comprises: recovering, based on the diffusion latent feature, a reconstructed image; computing an embedded latent feature based on the reconstructed image; and computing, based on the embedded latent feature and using one of the baseline image output or the vision-language latent feature as a diffusion condition, the supplement output.

Optionally, in a third implementation according to any of the fourth aspect through eighth aspect, or any implementation thereof, wherein computing the supplementary output comprises: computing an embedded latent feature based on the diffusion latent feature; and computing, based on the embedded latent feature and using one of the baseline image output or the vision-language latent feature as a diffusion condition, the supplement output.

Optionally, in a fourth implementation according to any of the fourth aspect through eighth aspect, or any implementation thereof, wherein computing the supplement output uses a Denoising Diffusion Probabilistic Model (DDPM) or a Denoising Diffusion Implicit Model (DDIM).

Optionally, in a fifth implementation according to any of the fourth aspect through eighth aspect, or any implementation thereof, wherein computing the supplement output comprises: computing, based on the embedded latent feature and the embedded latent feature, a reverse prediction output; and computing, based on the reverse prediction output, the supplement output.

Optionally, in a sixth implementation according to any of the fourth aspect through eighth aspect, or any implementation thereof, wherein when the baseline image output is used as the diffusion condition, computing the supplement output comprises encoding, using an embedding network, the baseline image output from a pixel domain to a latent domain.

Optionally, in a seventh implementation according to any of the fourth aspect through eighth aspect, or any implementation thereof, wherein when the vision-language latent feature is used as the diffusion condition, computing the supplement output comprises transforming, using a transformation network, the vision-language latent feature to a dimension corresponding to the embedded latent feature.

A ninth aspect relates to an apparatus comprising a memory or storage means configured to store instructions; and one or more processors or processing means coupled to the memory or the storage means and configured to execute the instructions to cause the apparatus to perform the method according to any of the preceding aspect or any implementation thereof.

A tenth aspect relates to a computer program product comprising computer-executable instructions stored on a non-transitory computer-readable storage medium, the computer-executable instructions when executed by a processor of an apparatus, cause the apparatus to perform the method according to any of the preceding aspect or any implementation thereof.

For clarity, any one of the foregoing embodiments may be combined with any one or more of the other foregoing embodiments to create a new embodiment within the scope of the present disclosure.

These and other features, and the advantages thereof, will be more clearly understood from the following detailed description taken in conjunction with the accompanying drawings and claims.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a diagram illustrating a general processing pipeline for AIGC.

FIG. 2 is a diagram illustrating a general framework for LIC.

FIG. 3 is a diagram illustrating a general framework for compression for machines (CfM).

FIG. 4 is a diagram illustrating a general framework for Learned Sparse Image Representation (LSIR).

FIG. 5A illustrates an encoding/decoding framework according to an embodiment of the present disclosure.

FIG. 5B illustrates an encoding/decoding framework according to an embodiment of the present disclosure.

FIG. 6A illustrates an encoding/decoding framework according to an embodiment of the present disclosure.

FIG. 6B illustrates an encoding/decoding framework according to an embodiment of the present disclosure.

FIG. 6C illustrates an encoding/decoding framework according to an embodiment of the present disclosure.

FIG. 6D illustrates an encoding/decoding framework according to an embodiment of the present disclosure.

FIG. 7 illustrates a detailed workflow of a vision-language branch according to an embodiment of the present disclosure.

FIG. 8A illustrates a processing workflow of a control branch according to an embodiment of the present disclosure.

FIG. 8B illustrates a processing workflow of a control branch according to an embodiment of the present disclosure.

FIG. 9 illustrates a processing workflow of a control adjustment module according to an embodiment of the present disclosure.

FIG. 10A illustrates a processing workflow of a diffusion branch according to an embodiment of the present disclosure.

FIG. 10B illustrates a processing workflow of a diffusion branch according to an embodiment of the present disclosure.

FIG. 11A and FIG. 11B illustrate a reverse diffusion module according to two embodiments of the present disclosure.

FIG. 12 is a diagram illustrating an apparatus according to an embodiment of the present disclosure.

### DESCRIPTION OF EMBODIMENTS

It should be understood at the outset that, although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various systems and methods for encoding and decoding an image. The present disclosure proposes a general framework that uses the powerful multi-modal representation learning in AIGC for LIC, which exploits the knowledge from the text-domain large language model (LLM) and the image-text-joint-domain VLM to achieve high compression efficiency and flexible control in LIC for different tasks targeting at both human consumption and machine consumption. Embodiments of the present disclosure provide a high compression rate, flexible quality control, flexible task-oriented control through prompts, and AIGC-guided compression on demand.

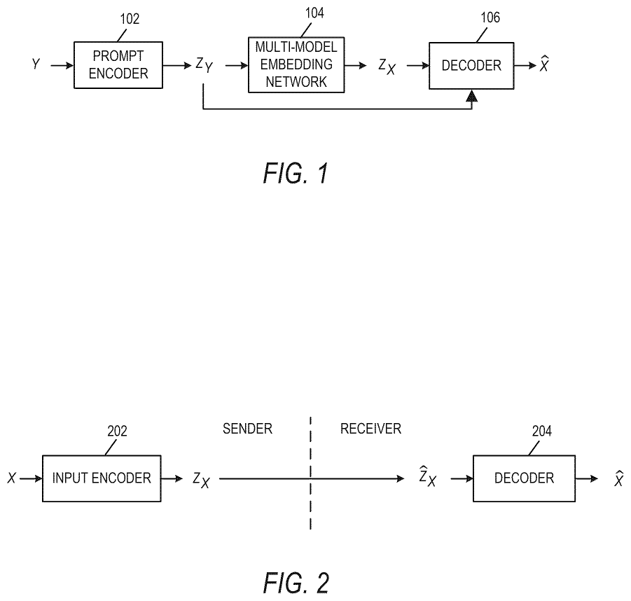

FIG. 1 is a diagram illustrating a general processing pipeline for AIGC. A prompt input y is passed through a prompt encoder 102. The prompt input y may be a text input that provides a description of content to be generated using AI. In some embodiments, the prompt input y may also include images related to the to-be-generated AI content. The prompt encoder 102 is a component configured to encode the input prompts y into a format that a multi-modal embedding network 104 can understand and process. In an embodiment, the prompt encoder 102 is configured to generate a prompt embedding feature z_{y} from the prompt input y, which represents the prompt input y encoded into an input format for the multi-modal embedding network 104. The prompt embedding feature z_{y} captures the semantic meaning and contextual information of the prompt input y, enabling the multi-modal embedding network 104 to understand and process the input effectively. The multi-modal embedding network 104 is a type of neural network architecture designed to merge information from multiple modalities, such as text, images, audio, or other types of data. In an embodiment, the multi-modal embedding network 104 is configured to compute an image embedding feature z_{y} that models the prior of P(z_{y}|zₓ). In an embodiment, the image embedding feature zₓ is a numerical representation of an image in a high-dimensional vector space. The image embedding feature zₓ is passed to a decoder 106. The decoder 106 is a decoding neural network configured to compute an output image \hat{x} based on the image embedding feature zₓ and the prompt embedding feature z_{y}. The target is to achieve high visual perceptual quality (e.g., natural and photo realistic, low level of visible artifacts) of the generated image \hat{x}, and the semantic alignment of \hat{x} to the requirement described by the prompt input y.

FIG. 2 is a diagram illustrating a general framework for LIC. LIC is a modern approach to image compression that utilizes deep learning techniques to learn efficient representations of images. Traditional image compression techniques rely on handcrafted algorithms that transform the image data into a compressed format. However, LIC aims to improve compression efficiency by training neural networks to automatically learn the most effective compression strategies directly from the data. LIC based on neural networks (NN) has been largely studied in recent years and has shown superior performance over traditional coding methods like Joint Photographic Experts Group (JPEG), Versatile Video Coding (VVC), and High Efficiency Video Coding (HEVC). In the depicted embodiment, on a sender side, an input image x is passed through an input encoder 202 to generate an image embedding feature zₓ, which is a representation of the input image x in a numerical format. In an embodiment, the input encoder 202 is a neural network configured to convert the raw pixel values of the input image x into a compressed and semantically meaningful numerical representation in a high-dimensional vector space. In some embodiments, the image embedding feature zₓ is further compressed through quantization and arithmetic coding into a data string that is efficient for storage and transmission from the sender to a receiver.

In an embodiment, on the receiver side, a decoded image embedding feature \hat{z}ₓ is recovered from the received data string sent by the sender using arithmetic decoding and dequantization. The decoded image embedding feature \hat{z}ₓ is used as input for a decoder 204. The decoder 204 is configured to reconstruct an output image \hat{x} based on the decoded image embedding feature \hat{z}ₓ. The target is to minimize the restoration loss between the reconstructed output \hat{x} and the original input x, and to minimize the bits to represent the image embedding feature zₓ for storage and transmission.

Traditionally, compression methods are developed for human consumption. That is, the reconstructed output x is targeted to be viewed by human, and the goal is to preserve high visual quality. The compression induced artifacts in \hat{x} can largely degrade the performance of some machine analytic tasks, such as detection and recognition tasks, since the information needed for such tasks may be altered or lost during compression. To facilitate machine analytics, standard activities such as the Moving Picture Experts Group (MPEG) Video Coding for Machines (VCM) and JPEG-AI have been launched to investigate compression method that are suitable for machine analytic tasks.

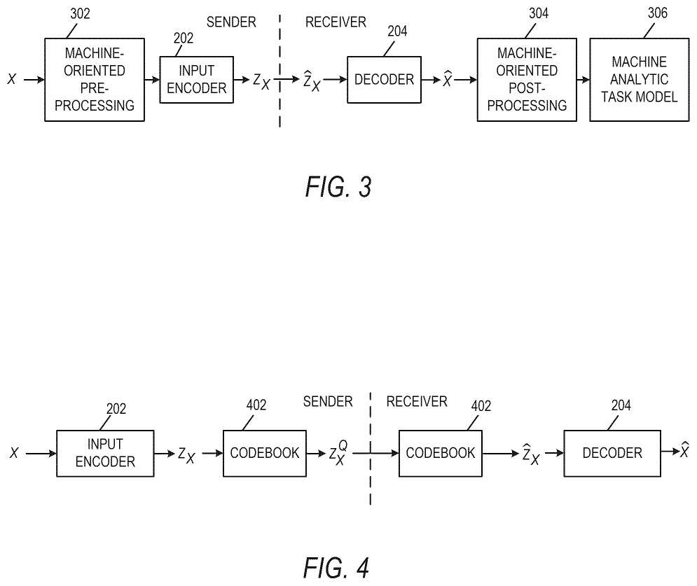

FIG. 3 is a diagram illustrating a general framework for CfM. In FIG. 3, a machine-oriented pre-processing module 302 and/or machine-oriented post-processing module 304 are used before and/or after a video compression method (e.g., VVC, HEVC, LIC, etc.) to pre-process the input image x before the input encoder 202 (as described in FIG. 2) and/or post-process the reconstructed output \hat{x} after the decoder 204 (as described in FIG. 2) for a connected target machine analytic task model 306. In an embodiment, the machine-oriented pre-processing module 302 and/or the machine oriented post-processing module 304 are optimized with the machine analytic task model in the end-to-end fashion (while keeping the video compression method and the machine analytic task model unchanged) by using the task performance loss. In an embodiment, one set of the machine-oriented pre-processing module 302 and/or the machine oriented post-processing module 304 are used for each specific task model of each machine analytic task.

FIG. 4 is a diagram illustrating a general framework for Learned Sparse Image Representation (LSIR). In LSIR, a vector-quantized autoencoder in the image domain is trained based on adversarial and perceptual loss (e.g., using the Vector Quantized Generative Adversarial Network (VQGAN) method) to learn a highly compressed codebook 402. The learned codebook 402 comprises a collection of codewords used in a compression algorithm. The goal is to represent an image using a set of codewords from the codebook 402 more efficiently than directly encoding each vector or group of pixels within the image. The learned codebook 402 is optimized end-to-end to balance codebook efficiency and reconstruction quality. As shown in FIG. 4, an input image x is passed through the input encoder 202 to generate the image embedding feature zₓ as described in FIG. 2. For LSIR, on the sender side, the image embedding feature zₓ is mapped into a sequence of code indices

$${z}_{x}^{q}$$

using the learned codebook 402. The code indices

$${z}_{x}^{q}$$

are integers that can be effectively stored or transmitted from the sender to a receiver. On the receiver side, the same learned codebook 402 is used to recover the decoded image embedding feature \hat{z}ₓ (e.g., by using the codewords in the codebook 402 corresponding to the received code indices

$${z}_{x}^{q} ) .$$

The decoder 204 is then configured to reconstruct an output image \hat{x} based on the decoded image embedding feature \hat{z}ₓ.

The current LIC framework, as described in FIG. 2, relies on learning a general compact image representation (i.e., a latent space where the image embedding feature zₓ can capture the gist of the input x to reconstruct \hat{x}). This framework has several severe limitations. First, the compression performance is innately bounded by the model capacity (e.g., the network structure and number of parameters of the input encoder 202 and the decoder 204) in learning the general prior P(x|zₓ) in the image domain. Due to the limited model capacity, limited training data, and limited computation resources in both training and test stage, it is hard to further improve the compression performance beyond a good baseline. Second, the LIC models are learned to balance the competing goals in the rate-distortion (RD) loss, where reducing reconstruction distortion and reducing bitrate contradict with each other. It is hard to improve the compression performance and the perceptual quality at the same time, due to the difficulty in balancing different loss terms in end-to-end training.

The current CfM framework, as described in FIG. 3, has little flexibility or generality since one set of machine-oriented pre-processing module 302 and/or machine-oriented post-processing module 304 are customized for a specific task model of each task. When multiple tasks (e.g., multiple levels of recognition) are needed, the CfM framework needs to compute and transmit multiple encoded streams using multiple sets of model parameters.

Comparing with LIC, the current LSIR framework, as described in FIG. 4, provides inferior performance in image compression. This is because when used for compression, LSIR has an aggressive goal of high compression rate by using a compact codebook (i.e., the learned codebook 402 in FIG. 4) to model the complicated generic image prior P(x|zₓ). The reconstructed image usually lacks expressive and fidelity details. In addition, it is quite challenging to flexibly control the compression result to fit different compression targets, such as to preserve the fidelity, to improve perceptual quality, or to fulfil other needs of using the image.

A compression method with flexibility, scalability, and generality that can suit various compression needs is highly desired for practical usage. The present disclosure proposes a general framework that uses the powerful multi-modal representation learning in AIGC for LIC, which exploits the knowledge from the text-domain LLM and the image-text-joint-domain VLM to achieve high compression efficiency and flexible control in LIC for different tasks targeting at both human consumption and machine consumption. The disclosed framework leverages several methods including LSIR, diffusion model, and large-scale VLM, to achieve high compression rate and high reconstruction quality at the same time. However, it is non-trivial to use AIGC for LIC. For instance, as described in FIG. 1 and FIG. 2, AIGC and LIC have different goals. LIC, as shown in FIG. 2, requires reconstruction of the original input x, while the current AIGC framework, as shown in FIG. 1, is not designed to guarantee such a requirement. That is, from the prompt input y, the generated \hat{x} is drawn from the joint distribution P(x, y|z_{y}, zₓ), which is usually not a reconstructed version of the original input x.

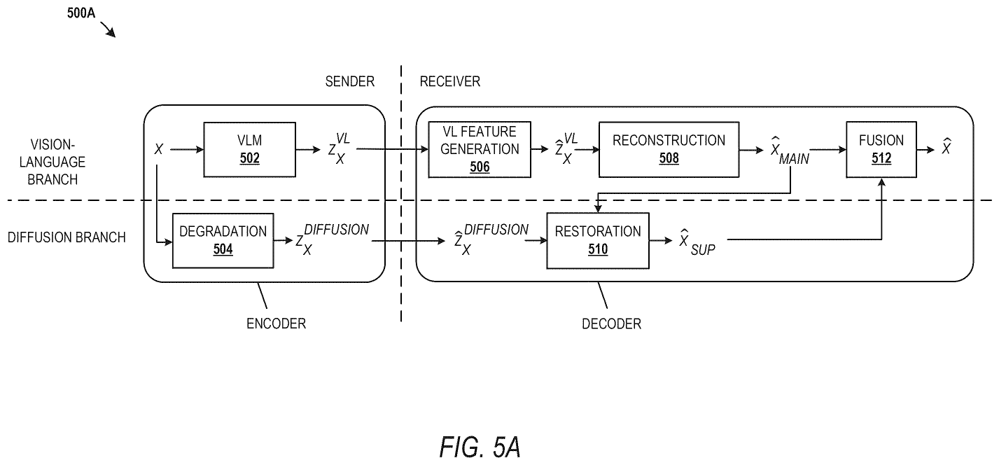

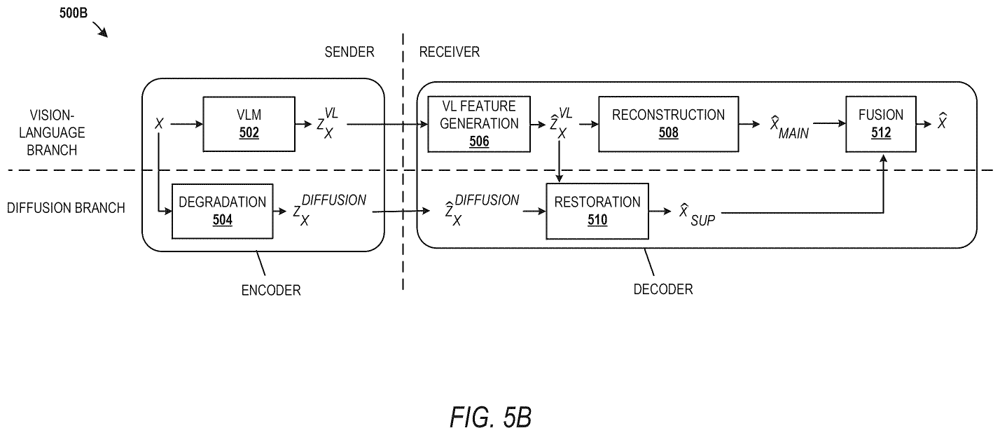

FIG. 5A illustrates an encoding/decoding framework 500A according to an embodiment of the present disclosure. The encoding/decoding framework 500A has two processing branches: a vision-language branch and a diffusion branch. As shown in FIG. 5A, on the sender sider, the encoder in the vision-language branch uses a VLM 502 to encode, by using a Learned Sparse Vision-Language Representation (LSVLR) (e.g., the learned codebook 402 in FIG. 4), the original input x into a vision-language latent feature

$${z}_{x}^{VL} .$$

A VLM IS a moder that combines both visual and linguistic information. VLMs typically consist of two main components: a vision encoder and a language encoder. The vision encoder processes visual inputs (such as images) to extract meaningful features, while the language encoder processes textual inputs (such as captions or questions) to understand their semantic meaning. The vision encoder and language encoder are then connected to a joint representation layer, where the information from both modalities is fused together. VLMs may be used for various tasks such as image captioning, visual question answering (VQA), and image-text matching. The vision-language latent feature comprises

$${z}_{x}^{VL}$$

comprises text and integers representing hidden features of the original input x, which can be efficiently transmitted to a decoder.

Additionally, the encoder in the diffusion branch, computes, using a degradation module 504, a diffusion latent feature

$${z}_{x}^{Diffusion}$$

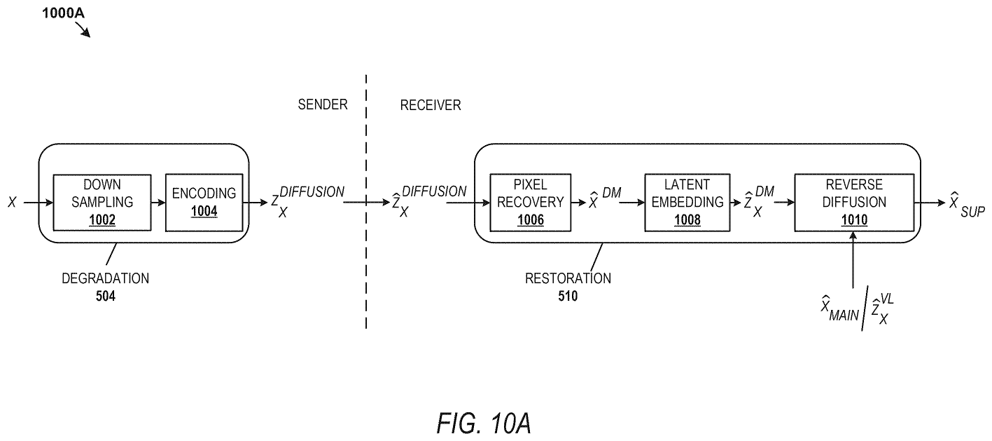

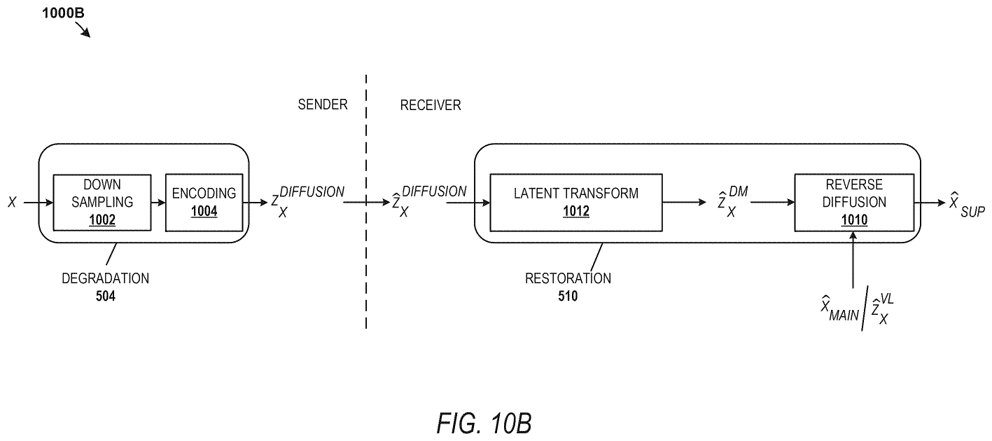

based on the original input x. Details of the degradation module 504 are described below in FIG. 10A. The diffusion latent feature

$${z}_{x}^{Diffusion}$$

captures the gist of the fidelity and expressiveness details of the original image x. The latent feature

$${z}_{x}^{Diffusion}$$

consumes very low bitrate to transmit and may be further compressed by quantization and arithmetic coding. The vision-language latent feature

$${z}_{x}^{VL}$$

and the diffusion latent feature

$${z}_{x}^{Diffusion}$$

are transmitted from the encoder or sender sider to the decoder on the receiver side.

In FIG. 5A, on the receiver side, in the main branch, the received

$${z}_{x}^{VL}$$

is passed to a vision-language (VL) feature generation module. The VL feature generation module 506 is configured to compute a decoded vision-language feature

$${\hat{z}}_{x}^{VL}$$

based on the received

$${z}_{x}^{VL} .$$

A reconstruction module 508 is configured to compute a baseline image output \hat{x}ₘₐᵢₙ based on the decoded vision-language feature

$${\hat{z}}_{x}^{VL} .$$

As shown in FIG. 5A, the baseline image output \hat{x}ₘₐᵢₙ will be combined with supplementary information from the diffusion branch to reconstruct the final output \hat{x}. In an embodiment, in the diffusion branch, the decoder uses a conditional diffusion model (CDM) to generate the fidelity details to supplement the main branch and compute the final output \hat{x}. A CDM is a type of probabilistic generative model used for modeling complex distributions. The CDM employs a diffusion process that gradually transforms known distribution into the target distribution through a series of diffusion steps, where noise is added to the data at each step to gradually modify the data until the data resembles the target distribution. The conditional aspect in CDMs refers to the ability of the model to generate data conditioned on some input information. As an example, in FIG. 5A, in the diffusion branch, the decoder receives the diffusion latent feature

$${z}_{x}^{Diffusion}$$

and performs decompression (e.g., using arithmetic decoding and dequantization) to obtain a decoded diffusion latent feature

$${\hat{z}}_{x}^{Diffusion} .$$

The decoded diffusion latent feature

$${\hat{z}}_{x}^{Diffusion}$$

is then used as an input into a restoration module 510 employing a CDM. In this embodiment, the restoration module 510 is configured to compute the supplementary output \hat{x}ₛᵤₚ, using the baseline output \hat{x}ₘₐᵢₙ as a condition of the CDM. The supplementary output \hat{x}ₛᵤₚ provides the fidelity details to supplement the baseline image output \hat{x}ₘₐᵢₙ from the main branch. The supplementary output \hat{x}ₛᵤₚ and the baseline image output \hat{x}ₘₐᵢₙ are passed to a fusion module 512. The fusion module 512 is configured to combine the supplementary output \hat{x}ₛᵤₚ and the baseline image output \hat{x}ₘₐᵢₙ to reconstruct the final output \hat{x}, which represents a decoded image of the original input x. In all of the disclosed embodiments, the decoder may then transmit the final output \hat{x} to a display device for displaying of the decoded image, or transmit the final output \hat{x} to another computing device such as, but not limited to, a client device that requested the image. In some embodiments, the decoder may pass the decoded image to another application (e.g., an image editing application) for further processing.

FIG. 5B illustrates an encoding/decoding framework 500B according to an embodiment of the present disclosure. The encoding/decoding framework 500B is similar to the encoding/decoding framework 500A in FIG. 5A, except that in the decoder, the restoration module 510 is configured to compute the supplementary output \hat{x}ₛᵤₚ using the decoded vision-language feature

$${\hat{z}}_{x}^{VL}$$

as a condition, as opposed to the baseline output \hat{x}ₘₐᵢₙ in FIG. 5A.

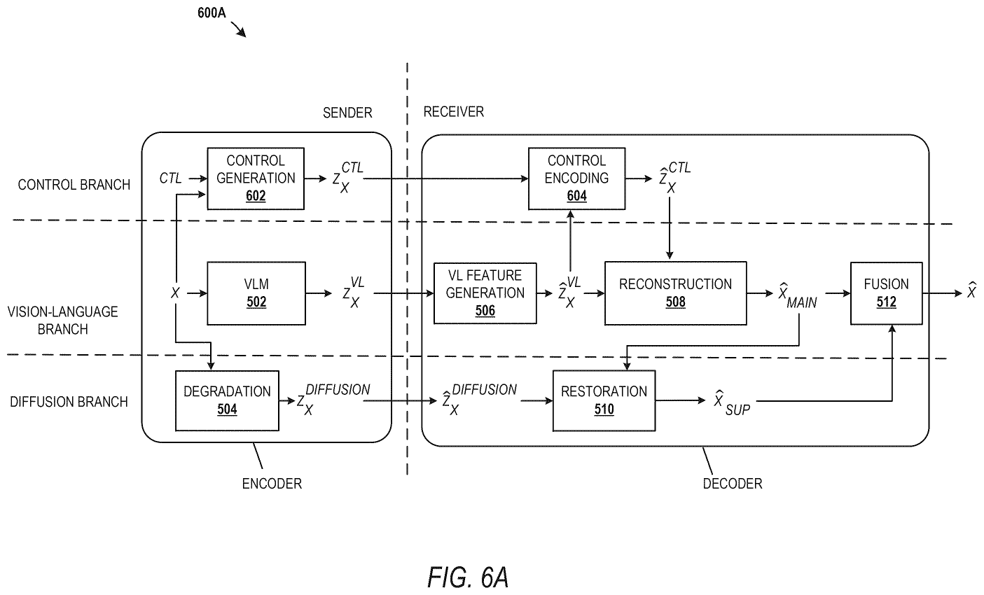

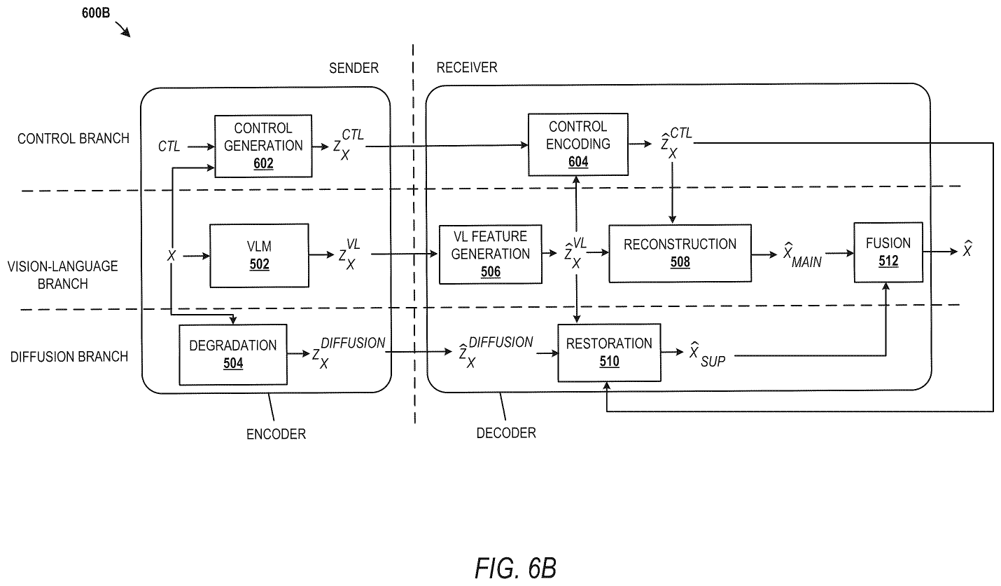

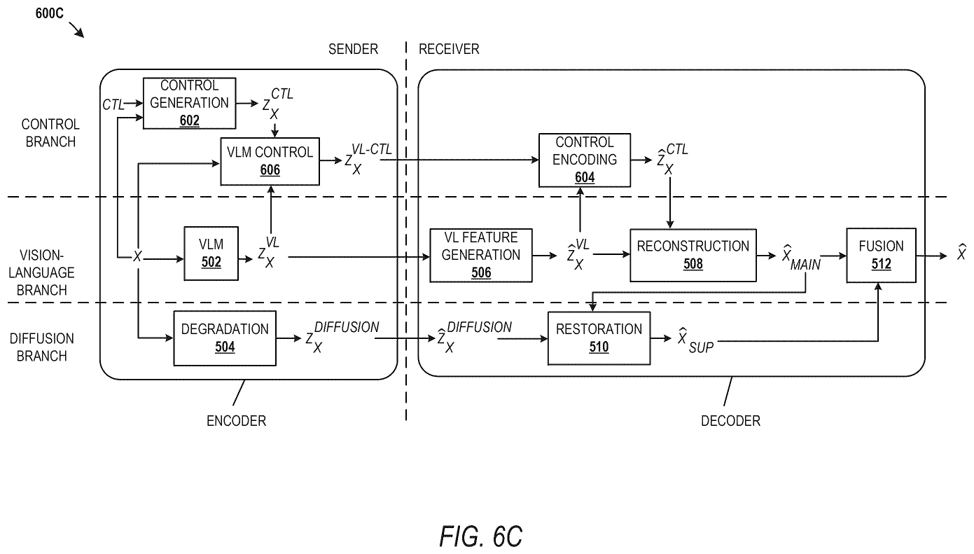

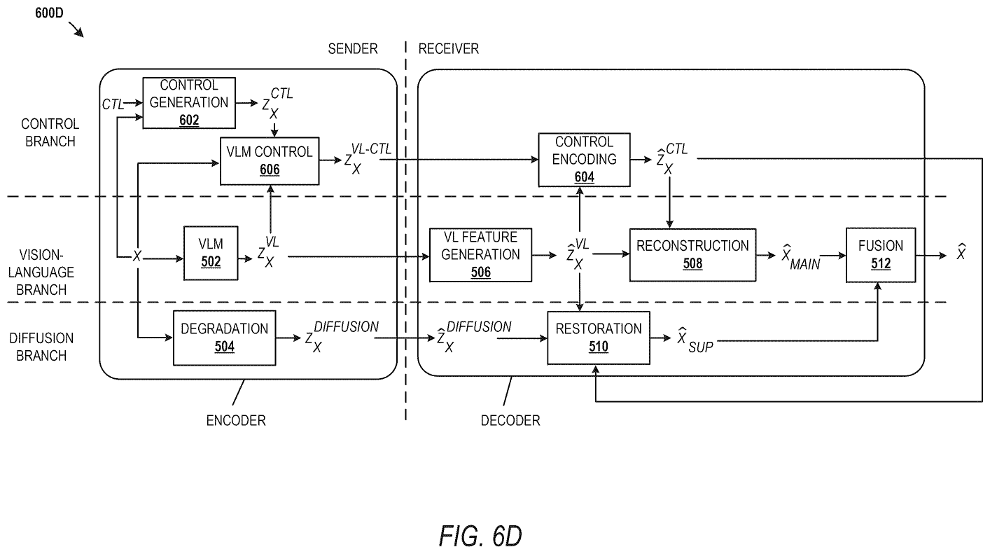

FIG. 6A illustrates an encoding/decoding framework 600A according to an embodiment of the present disclosure. Similar to the encoding/decoding framework 500A in FIG. 5A, the encoding/decoding framework 600A includes a vision-language branch and a diffusion branch. As described in FIG. 5A, on the sender sider, the encoder, in the vision-language branch, based upon an LSVLR, uses the VLM 502 to encode the original input x into a vision-language latent feature

$${z}_{x}^{VL} .$$

The encoder in the diffusion branch computes, using the degradation module 504, a diffusion latent feature

$${z}_{x}^{Diffusion}$$

based on the original input x. In contrast to the encoding/decoding framework 500A in FIG. 5A, the encoding/decoding framework 600A includes a control branch that incorporates a control parameter or instruction for encoding/decoding an image. For example, the control branch may be used to ensure the reconstruction quality of a specific object in a scene of an image. In the depicted embodiment, on the sender side, in the control branch, a control generation module 602 is configured to receive as inputs a control signal ctl and the original input x, and generate a control latent requirement

$${z}_{x}^{ctl} .$$

The control latent requirement

$${z}_{x}^{ctl}$$

comprises text and integers (e.g., a few numbers) representing the encoded control requirement. The control latent requirement

$${z}_{x}^{ctl}$$

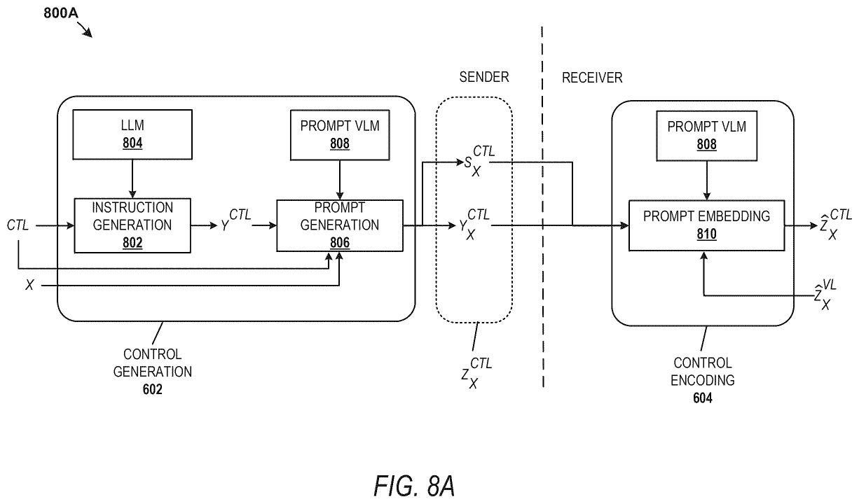

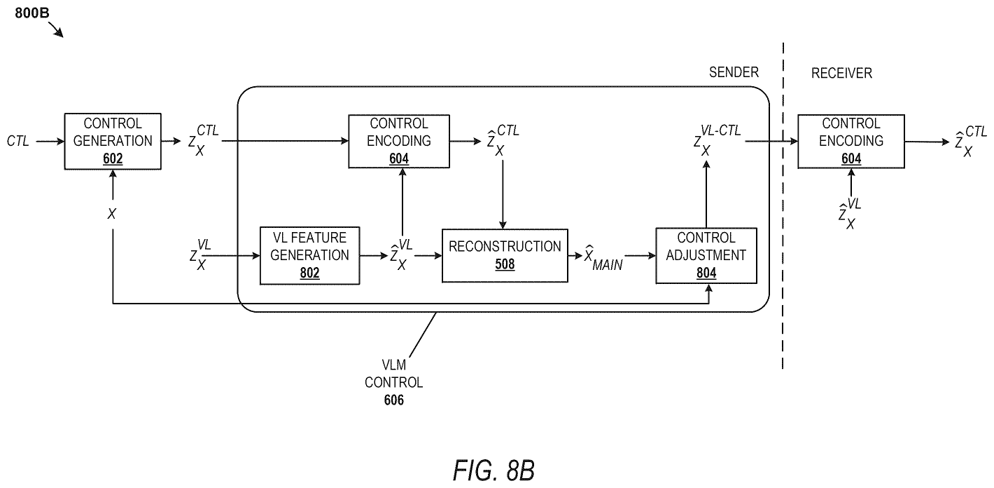

is transmitted to the receiver side with little bit consumption (i.e., consumes little bandwidth). In some embodiments, the control signal ctl can take many different forms, such as one or a combination of the following control mechanisms: a text description, a sketch drawing, a bounding box, a color panel, etc. Additional details regarding the control branch is further described in FIG. 8.

On the receiver side, the decoder includes a control encoding module 604. In this embodiment, the control encoding module 604 is configured to compute an encoded control feature

$${\hat{z}}_{x}^{ctl}$$

based on the received control latent requirement

$${z}_{x}^{ctl}$$

and the decoded vision-language feature

$${\hat{z}}_{x}^{V L} .$$

As described in FIG. 5A, the decoded vision-language feature

$${\hat{z}}_{x}^{V L}$$

is generated by the VL feature generation module 506, in the vision-language branch, based on the vision-language latent feature

$${z}_{x}^{V L} .$$

Then, in the vision-language branch of FIG. 6A, the encoded control feature

$${\hat{z}}_{x}^{ctl}$$

and the decoded vision-language feature

$${\hat{z}}_{x}^{V L}$$

are fed into the reconstruction module 508 to guide the reconstruction process so that the baseline image output \hat{x}ₘₐᵢₙ and, consequently, the reconstructed \hat{x} satisfies the requirements described by the control signal ctl. Similar to FIG. 5A, in the diffusion branch, the restoration module 510 is configured to compute, based on the decoded diffusion latent feature

$${\hat{z}}_{x}^{Diffusion} ,$$

the supplementary output \hat{x}ₛᵤₚ using the baseline output \hat{x}ₘₐᵢₙ as a condition of the CDM of the restoration module 510. The supplementary output \hat{x}ₛᵤₚ and the baseline image output \hat{x}ₘₐᵢₙ are passed to the fusion module 512. The fusion module 512 is configured to combine the supplementary output \hat{x}ₛᵤₚ and the baseline image output \hat{x}ₘₐᵢₙ to reconstruct the final output \hat{x}, which represents a decoded image of the original input x. As previously, stated the final output \hat{x} satisfies the requirements described by the control signal ctl.

FIG. 6B illustrates an encoding/decoding framework 600B according to an embodiment of the present disclosure. The encoding/decoding framework 600B includes a control branch, a vision-language branch, and a diffusion branch. On the sender sider, the encoder of the encoding/decoding framework 600B is configured the same as the encoder of the encoding/decoding framework 600A in FIG. 6A. Similarly, on the receiver side, in the control branch of the decoder, the control encoding module 604 is configured to compute an encoded control feature

$${\hat{z}}_{x}^{ctl}$$

based on the received control latent requirement

$${z}_{x}^{ctl}$$

and the decoded vision-language feature

$${\hat{z}}_{x}^{V L} .$$

In the vision-language branch of FIG. 6B, the encoded control feature and the decoded vision-language feature

$${\hat{z}}_{x}^{ctl}$$

and the decoded vison-language feature

$${\hat{z}}_{x}^{V L}$$

are fed into the reconstruction module 508 to guide the reconstruction process so that the baseline image output \hat{x}ₘₐᵢₙ. In contrast to the encoding/decoding framework 600A in FIG. 6A, in the diffusion branch of the encoding/decoding framework 600B in FIG. 6B, the restoration module 510 is configured to compute, based on the decoded diffusion latent feature

$${\hat{z}}_{x}^{Diffusion} ,$$

the supplementary output \hat{x}ₛᵤₚ using the decoded vision-language feature

$${\hat{z}}_{x}^{VL}$$

and the encoded control feature

$${\hat{z}}_{x}^{ctl}$$

as conditions to guide the diffusion process to generate the residual details to supplement the initial estimate \hat{x}ₘₐᵢₙ. The supplementary output \hat{x}ₛᵤₚ and the baseline image output \hat{x}ₘₐᵢₙ are passed to the fusion module 512. The fusion module 512 is configured to combine the supplementary output \hat{x}ₛᵤₚ and the baseline image output \hat{x}ₘₐᵢₙ to reconstruct the final output x, which satisfies the requirements described by the control signal ctl.

FIG. 6C illustrates an encoding/decoding framework 600C according to an embodiment of the present disclosure. The encoding/decoding framework 600C includes a control branch, a vision-language branch, and a diffusion branch. As previously described, on the sender side, in the control branch, the control generation module 602 is configured to receive as inputs a control signal ctl and the original input x, and generate a control latent requirement

$${z}_{x}^{ctl} .$$

In contrast FIG. 6A and FIG. 6B, on the sender sider, the control latent requirement

$${z}_{x}^{ctl}$$

and the vision-language latent feature

$${z}_{x}^{VL}$$

(generated in the vision-language branch as described in FIG. 5A) are used as input for a VLM control module 606 that is configured to compute a vision-language control latent feature

$${z}_{x}^{VL - ctl} .$$

In an embodiment, the vision-language control latent feature

$${z}_{x}^{VL - ctl}$$

comprises integers, text, and a few numbers that can be easily transmitted to the receiver (i.e., are lightweight to transmit). The vision-language control latent feature

$${z}_{x}^{VL - ctl}$$

represents a control instruction or requirements of the final decoded image \hat{x} that has been supplemented or refined based on the vision-language latent feature

$${z}_{x}^{VL}$$

(e.g., contains text words and/or sentences as well as other prompt information (such as bounding box, importance weights) that can reflect the requirements of the control signal ctl).

On the receiver side, the decoder, in the control branch, computes the encoded control feature

$${\hat{z}}_{x}^{ctl}$$

using the control encoding module 604 based on the vision-language control latent feature

$${z}_{x}^{VL - ctl}$$

and the decoded vision-language feature

$${\hat{z}}_{x}^{VL} .$$

After computing the encoded control feature

$${\hat{z}}_{x}^{ctl} ,$$

the decoder in the encoding/decoding framework 600C is then similarly configured as the decoder described in the encoding/decoding framework 600A of FIG. 6A.

FIG. 6D illustrates an encoding/decoding framework 600D according to an embodiment of the present disclosure. The encoding/decoding framework 600D includes a control branch, a vision-language branch, and a diffusion branch. On the sender side, the encoder in the encoding/decoding framework 600D is the same as the encoder described in the encoding/decoding framework 600C of FIG. 6C. On the receiver side, the decoder, in the control branch, computes the encoded control feature

$${\hat{z}}_{x}^{ctl}$$

using the control encoding module 604 based on the vision-language control latent feature

$${z}_{x}^{VL - ctl}$$

and the decoded vision-language feature

$${\hat{Z}}_{x}^{VL} .$$

After computing the encoded control feature

$${\hat{Z}}_{x}^{ctl} ,$$

the decoder in the encoding/decoding framework 600D is then similarly configured as the decoder described in the encoding/decoding framework 600B of FIG. 6B

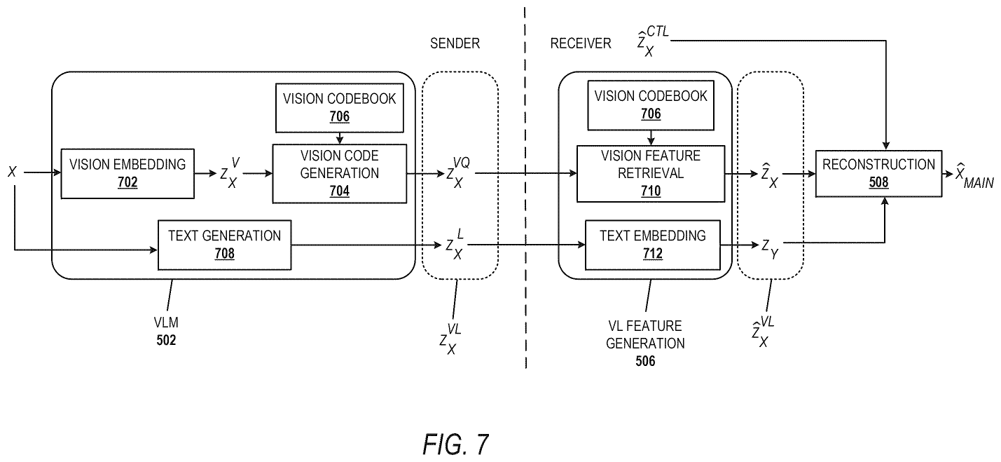

FIG. 7 illustrates a detailed workflow of a vision-language branch according to an embodiment of the present disclosure. In the depicted embodiment, on the sender side, the original image x is given as input to the VLM 502. In an embodiment, the original image x is a general 3D tensor with shape w×h×c, where w, h, c are the width, height, and number of channels of the image. For example, c=3 for color images, c=1 for spectral images, or c=4 for RGB-D (color and depth) images. The VLM 502 includes a vision embedding module 702 configured to encode the original image x into a vision feature tensor

$${Z}_{x}^{V}$$

with snape wₓ×hₓ×d, where the width wₓ and height hₓ depend on the input width and height as well as the network structure of the vision embedding module 702, and where d is the number of feature channels. Various neural networks can be used as the vision embedding module 702. For example, in one embodiment, a visual transformer (ViT) is used. The ViT is configured to divide the original image x into patches and encode the patches as a sequence. In another embodiment, a convolutional neural network (CNN) structure is used where the entire original image x is encoded in a parallel manner.

The vision feature tensor

$${Z}_{x}^{V}$$

is then passed to a vision code generation module 704. The vision code generation module 704 is configured to compute a sparse codebook-based latent feature

$${Z}_{x}^{Vq}$$

based on the vision feature tensor

$${Z}_{x}^{V}$$

and a vision codebook C_{V} 706. In an embodiment, the vision codebook C_{V} 706 comprises of N_{V} of codewords, each having d dimensions. Each pixel

$${Z}_{x , l}^{Vq}$$

in

$${Z}_{x}^{Vq}$$

(l=1, . . . , wₓ×hₓ) corresponds to a codeword

$${c}_{V}^{l} ∈ {C}_{V}$$

that is nearest to the corresponding latent feature

$${Z}_{x , l}^{V} :$$

$${c}_{V}^{l} = arg {min}_{{c}_{V , k} ∈ {C}_{V}} Dist ( {C}_{V , k} , {Z}_{x , l}^{V} ) ,$$

where Dist( ) is a distance metric, such as L1 or L2 norm. The L1 norm is the sum of the absolute value of the entries in the vector. The L2 norm is the square root of the sum of the entries of the vector. That is, the entire sparse codebook-based latent feature

$${Z}_{x}^{Vq}$$

has wₓ×hₓ integers corresponding to the indices of wₓ×hₓ codewords. The sparse codebook-based latent feature

$${Z}_{x}^{Vq}$$

can be efficiently transmitted to the decoder in a lossless way with very little bit consumption.

Additionally, on the sender side, the original image x is fed into a text generation module 708 to compute a language latent feature

$${Z}_{x}^{L} .$$

In an embodiment, the language latent feature

$${z}_{x}^{L}$$

contains text words and/or sentences that can be efficiently transmitted to the decoder. In an embodiment, the text generation module 708 is an image grounded text generator (IGTG), which generates text description describing the content of the original image x. In an embodiment, the IGTG uses a pre-trained multi-modal vision-language representation such as CLIP or BLIP that learns the joint prior P(x, y|z_{y}, zₓ) of the original image x and the associated text descriptions y joint prior P(x, y|z_{y}, zₓ), and computes the conditional P(y|x) based on the pre-trained multi-modal vision-language representation. As illustrated in FIG. 7, the sparse codebook-based latent feature

$${Z}_{x}^{L}$$

and the language latent feature

$${z}_{x}^{L}$$

are combined to produce the vision-language latent feature

$${z}_{x}^{VL} ,$$

which is sent to the decoder using low bit consumption.

On the receiver side, the sparse codebook-based latent feature

$${z}_{x}^{Vq}$$

is fed into a vision feature retrieval module 710. In an embodiment, the vision feature retrieval module 710 is configured to retrieve a decoded image embedding feature \hat{z}ₓ of shape wₓ×hₓ×d based on the same vision codebook C_{V} 706 as the sender. In an embodiment, each pixel of \hat{z}_{x,l} (l=1, . . . , wₓ×hₓ) is the codeword with index

$${z}_{x , l}^{Vq} .$$

Additionally, the language latent feature

$${z}_{x}^{L}$$

is fed into a text embedding module 712. In an embodiment, the text embedding module 712 is configured to compute a text embedding feature z_{y}. The decoded image embedding feature \hat{z}ₓ and the text embedding feature z_{y} when combined produces the decoded vision-language latent feature

$${\hat{z}}_{x}^{VL} .$$

As described in FIG. 6A-FIG. 6D, the encoded control feature

$${\hat{z}}_{x}^{ctl}$$

(from the control branch) and the decoded vision-language feature

$${\hat{z}}_{x}^{VL}$$

are fed into the reconstruction module 508 to guide the reconstruction process to obtain the baseline image output \hat{x}ₘₐᵢₙ. There are multiple ways to combine the decoded image embedding feature \hat{z}ₓ, the text embedding feature z_{y}, and the encoded control feature

$${\hat{z}}_{x}^{ctl}$$

in the reconstruction module 508. In one embodiment, the reconstruction module 508 can have a network structure of multiple CNN layers like the decoding network of a variational autoencoder (VAE). Then the text embedding feature z_{y} and the encoded control feature

$${\hat{z}}_{x}^{ctl}$$

are weighted combined with the decoded image embedding feature \hat{z}ₓ by tuning the decoded image embedding feature \hat{z}ₓ through an affine transformation to generate a new combined feature z_{xyc}=\hat{z}ₓ+w_{xyc}(β_{xyc}\hat{z}ₓ+Y_{xyc}) with a weight w_{xyc} and affine parameters

$${β}_{xyc} , {γ}_{xyc} \cdot {β}_{xy} , {γ}_{xy} = {θ}_{xyc} ( con ( {\hat{z}}_{x} , ρ ( {z}_{y} , {\hat{z}}_{x}^{ctl} ) ) ) ,$$

where con( ) is the concatenation operation and

$$ρ ( {z}_{y} , {\hat{z}}_{x}^{ctl} )$$

is an operation to aggregate information from z_{y} and

$${\hat{z}}_{x}^{ctl}$$

(e.g., through convolution). In another embodiment, the reconstruction module 508 is a decoder diffusion model such as a text-conditioned image generation model or a guided language to image diffusion for generation and editing (GLIDE) model, or other prompt-conditioned image generation models. The text embedding feature z_{y} and the encoded control feature

$${\hat{z}}_{x}^{ctl}$$

provide guidance to the image diffusion process.

FIG. 8A illustrates a processing workflow of a control branch 800A according to an embodiment of the present disclosure. The control branch 800A is a detailed example of the control branch described in FIG. 6A and FIG. 6B. In the depicted embodiment, on the sender side, the input control signal ctl is given as input to an instruction generation module 802 of the control generation module 602. As previously stated, the control signal ctl can take many different forms, such as one or a combination of the following control mechanisms: a text description, a sketch drawing, a bounding box, a color panel, etc. The instruction generation module 802 is configured to generate a text instruction y^{ctl} based on the control signal ctl using an LLM 804. The LLM 804 is a model configured to understand and generate human-like text. LLMs are trained on vast amounts of text data, learning the patterns and structures of language in order to generate coherent and contextually relevant text. Various types of LLMs may be used. Non-limiting examples include Generative Pre-trained Transformer (GPT-3) and Bidirectional Encoder Representations from Transformers (BERT). The text instruction y^{ctl} is a text description describing the control requirements of ctl.

The text instruction y^{ctl}, the original image x, and the control signal ctl are given as input into a prompt generation module 806. The prompt generation module 806, a prompt VLM module 808, is configured to generate an input-oriented text instruction

$${y}_{x}^{ctl}$$

and additional input-oriented prompt instruction

$${s}_{x}^{ctl}$$

based on the text instruction y^{ctl}, the original image x, the control signal ctl. The prompt VLM module 808 models the multimodal embedded representation between text descriptions, various forms of prompts, and images. For instance, a multimodal embedding of images and text descriptions learned with guidance from image segmentation masks can be used as the prompt VLM module 808. The additional input-oriented prompt instruction

$${s}_{x}^{ctl}$$

indicates bounding boxes locating the regions that are focus of the control signal ctl. For example, the control signal ctl may ensure the reconstruction quality of a specific object in the scene (e.g., ctl is text description “high quality (HQ) bear”). The enriched text instruction y^{ctl} elaborates on such requirements (e.g., y^{ctl} may be “ensure high quality and high resolution of the animal bear”). The input-oriented text instruction

$${y}_{x}^{ctl}$$

is computed to reflect the actual content of the input x (e.g.,

$${y}_{x}^{ctl}$$

is “ensure high quality and high resolution of the brown bear catching fish in the river”). The additional input-oriented prompt instruction

$${s}_{x}^{ctl}$$

can be the bonding box of the bear to focus on in the image.

The input-oriented text instruction

$${y}_{x}^{ctl}$$

and the additional input-oriented prompt instruction

$${s}_{x}^{ctl}$$

form the control latent requirement

$${z}_{x}^{ctl} ,$$

which is transmitted to the receiver side. On the receiver side, the input-oriented text instruction

$${y}_{x}^{ctl} ,$$

the additional input-oriented prompt instruction

$${s}_{x}^{ctl} ,$$

and the decoded vision-language feature

$${\hat{z}}_{x}^{VL}$$

(from the vision-language branch as described in FIG. 6A) are fed into a prompt embedding module 810 of the control encoding module 604. The prompt embedding module 810 is configured to compute the encoded control feature

$${\hat{z}}_{x}^{ctl}$$

by using the same prompt VLM module 808 that was used on the sensor side. For instance, because the prompt VLM module 808 models the multimodal embedded representation between text descriptions, various forms of prompts, and images, the text instruction

$${y}_{x}^{ctl}$$

and the additional input-oriented prompt instruction

$${s}_{x}^{ctl}$$

can be fed into this multimodal representation space to obtain the multimodal encoded feature

$${\hat{z}}_{x}^{ctl}$$

through a multimodal encoder. That is, the prompt embedding module 810 can be the encoder with the cross-attention mechanism from the prompt VLM module 808.

Note that the control signal ctl can vary based on different compression needs. For example, the control signal can be “Fidel bear” instead of “high quality (HQ) bear” to emphasize the reconstruction fidelity of the specific content instead of perceptual quality. Such requirements can be useful for successive detection and recognition tasks for machine analysis. Besides text descriptions, other types of prompts can be used as the control signal ctl, such as selecting a style of texture or a style of color. Another example is that the control signal ctl can include a text description “foliage background” and a warm foliage color panel. The enriched text instruction y^{ctl} can be “tune image to have foliage color.” The above two examples can be combined into one complex control signal cl such as “Fidel bear, foliage background,” and the enriched text instruction y^{ctl} can be “tune image to have foliage color while keeping the animal bear as original.” Accordingly, the input-oriented text instruction

$${y}_{x}^{ctl}$$

and the additional input-oriented prompt instruction

$${s}_{x}^{ctl}$$

will change to reflect such control instructions in guiding the reconstructed image.

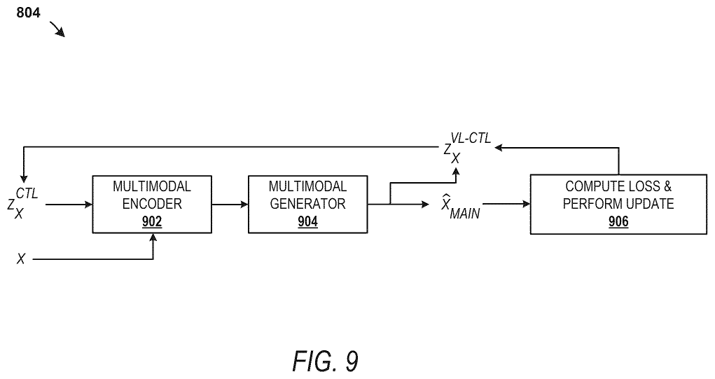

The cross-attention mechanism that are trained to capture the attention responses across multiple modalities including image, text, and various prompts can be used to implement the prompt VLM module 808, such as the cross-attention used in P2PE. One exemplar structure of the prompt VLM module 808 is a multimodal encoder with cross-attention followed by a multimodal generator as described in FIG. 9. Also, the network structure of adding conditional prompt control can be used to implement the prompt VLM module 808, where a desired type of prompt control such as sketches, masks, bounding boxes, etc., can be added to a basic VLM for text-image embedding. Embodiments of the present disclosure do not put any restriction on the network structure or training mechanism of how the prompt VLM module 808 is implemented.

FIG. 8B illustrates a processing workflow of a control branch 800B according to an embodiment of the present disclosure. The control branch 800B is a detail example of the control branch described in FIG. 6C and FIG. 6D. In the depicted embodiment, on the sender side, the original image x and the control signal ctl is provided as input to the control generation module 602. The control generation module 602 is configured to generate the control latent requirement

$${z}_{x}^{ctl} .$$

In an embodiment, the control latent requirement

$${z}_{x}^{ctl}$$

comprises the input-oriented text instruction

$${y}_{x}^{ctl}$$

and the additional input-oriented prompt instruction

$${s}_{x}^{ctl} .$$

Additionally, the vision-language latent feature

$${z}_{x}^{VL}$$

is passed to a VL feature generation module 802 of the VLM control module 606 described in FIG. 6C and FIG. 6D. The VL feature generation module 802 is configured to compute the decoded vision-language latent feature

$${\hat{z}}_{x}^{VL} .$$

In an embodiment, the VL feature generation module 802 is the same as the VL feature generation module 506 used in the decoder described in FIG. 6A-FIG. 6D.

The decoded vision-language latent feature

$${\hat{z}}_{x}^{VL}$$

and the control latent requirement

$${z}_{x}^{ctl}$$

are fed into the control encoding module 604 (same control encoding module 604 as the receiver side of the control branch described in FIG. 6A-FIG. 6D), which computes the encoded control feature

$${\hat{z}}_{x}^{ctl} .$$

The decoded vision-language latent feature

$${\hat{z}}_{x}^{VL}$$

and the encoded control feature

$${\hat{z}}_{x}^{ctl}$$

are passed to the reconstruction module 508 (same reconstruction module 508 as the receiver side of the vision-language branch described in FIG. 6A-FIG. 6D). The reconstruction module 508 is configured to compute the baseline image output \hat{x}ₘₐᵢₙ using both the encoded control feature

$${\hat{z}}_{x}^{ctl}$$

and the decoded vision-language latent feature

$${\hat{z}}_{x}^{VL} .$$

A control adjustment module 804 receives the baseline image output \hat{x}ₘₐᵢₙ and the original input image x as input. The control adjustment module 804 is configured to compute the vision-language control latent feature

$${z}_{x}^{VL - ctl}$$

based on the reconstructed baseline image output \hat{x}ₘₐᵢₙ and the original input image x. The control adjustment module 804 can take various strategies to compute the vision-language control latent feature

$${z}_{x}^{VL - ctl} .$$

An example of a processing workflow of the control adjustment module 804 is described in FIG. 10. The vision-language control latent feature

$${z}_{x}^{VL - ctl}$$

is transmitted to the receiver side.

On the receiver side, the vision-language control latent feature

$${z}_{x}^{VL - ctl}$$

and the decoded vision-language latent feature

$${\hat{z}}_{x}^{VL}$$

(from the vision-language branch of the decoder) are provided as input to the control encoding module 604 (same as the control encoding module 604 on the receiver side). The control encoding module 604 is configured to compute the encoded control feature

$${\hat{z}}_{x}^{ctl} .$$

FIG. 9 illustrates a processing workflow of the control adjustment module 804 according to an embodiment of the present disclosure. The control adjustment module 804 can take various strategies to compute the vision-language control latent feature

$${z}_{x}^{VL - ctl} .$$

In the depicted embodiment, the control adjustment module 804 includes a multimodal encoder 902 followed by a multimodal generator 904. The multimodal encoder 902 takes as input the original input image x and the text description and the other prompts of the control latent requirement

$${z}_{x}^{ctl} .$$

The multimodal encoder 902 is configured to compute the encoded image embedding, text embedding, and prompt embedding in the multimodal vision-language space. The multimodal generator 904 uses these encoded image embedding, text embedding, and prompt embedding to generate the baseline image output \hat{x}ₘₐᵢₙ and text description and prompts of the control latent requirement

$${z}_{x}^{ctl} .$$

In some embodiments, the distortion between the original input x and the baseline image output \hat{x}ₘₐᵢₙ is used by a compute loss and perform update module 906 to compute a distortion loss (e.g., mean square error (MSE)), which further updates the text description and prompts of the control latent requirement

$${z}_{x}^{ctl}$$

into the vision-language control latent feature

$${z}_{x}^{VL - ctl}$$

(e.g., through backpropagating the gradient of the loss automatically). In some other embodiments, manual adjustments can be performed to change the text description and prompts of the control latent requirement

$${z}_{x}^{ctl}$$

into the vision-language control latent feature

$${z}_{x}^{VL - ctl}$$

by observing the original image x and the baseline image output \hat{x}ₘₐᵢₙ. In some other embodiments, direct manipulation can be performed over the encoded image embedding, text embedding, and/or prompt embedding to change the vision-language control latent feature

$${z}_{x}^{VL - ctl}$$

(e.g., through random noise injection). The present disclosure does not place restrictions on how the control adjustment module 804 is implemented.

FIG. 10A illustrates a processing workflow of a diffusion branch 1000A according to an embodiment of the present disclosure. In general, the diffusion branch 1000A uses a CDM to provide, with little transmission bit costs, fidelity and expressiveness details from the original input image x to supplement the reconstructed output from the vision-language branch, so that the final output \hat{x} is authentic to the original input x. Specifically, in the depicted embodiment, the degradation module 504 includes a down sampling module 1002 and an encoding module 1004. The original input image x is first down sampled by the down sampling module 1002 to produce smaller resolution images that are then encoded by the encoding module 1004 into a diffusion latent feature

$${z}_{x}^{Diffusion} .$$

In some embodiments, the down sampling module 1002 can use a learned down sampling network or a preset method like bicubic filter. In some embodiments, the encoding module 1004 uses a compression method (e.g., traditional coding tools like VVC/HEVC/JPEG, or an LIC method). In some embodiments, a high compression rate is used in the encoding module 1004 and the diffusion latent feature

$${z}_{x}^{Diffusion}$$

has a small bitrate for transmission (usually further compressed by quantization and arithmetic coding).

On the receiver side, the decoded diffusion latent feature

$${\hat{z}}_{x}^{Diffusion}$$

(usually after arithmetic decoding and dequantization) is used to compute the supplementary output \hat{x}ₛᵤₚ through a CDM. In this embodiment, the decoded diffusion latent feature

$${\hat{z}}_{x}^{Diffusion}$$

is fed into a pixel recovery module 1006. The pixel recovery module 1006 is configured to recover a reconstructed image \hat{x}^{DM}. In an embodiment, the pixel recovery module 1006 is the image decoding process of the corresponding image encoding process used by the encoding module 1004 on the sender side. A latent embedding module 1008 is configured to compute an embedded latent feature

$${\hat{z}}_{x}^{DM}$$

based on the reconstructed image \hat{x}^{DM}. The latent embedding module 1008 is usually an encoder network such as the encoder part of a VAE. Then, using either the decoded vision-language latent feature

$${\hat{z}}_{x}^{VL}$$

(corresponding to the workflow of FIG. 6B and FIG. 6D) or the baseline image output \ddot{x}ₘₐᵢₙ (corresponding to the workflow of FIG. 6A and FIG. 6C) as a diffusion condition, the reverse diffusion module 1010 is configured to generate the supplement output \hat{x}ₛᵤₚ based on the embedded latent feature

$${\hat{z}}_{x}^{DM} .$$

It is worth mentioning that, when the encoding module 1004 is a traditional compression method like VVC/HEVC/JPEG, the framework in FIG. 10A will be used where the pixel recovery module 1006 is the corresponding decoding process of the compression method to compute the reconstructed image \hat{x}^{DM}. When the encoding module 1004 is an LIC method, the pixel recovery module 1006 can be the corresponding decoding process of the LIC method in framework of FIG. 10A, or the framework of FIG. 10B can be used where the intermediate decoded feature from the LIC can be directly transformed into the reconstructed image \hat{x}^{DM}. The present disclosure does not place any restrictions on what compression method to use or what intermediate decoded feature to use.

FIG. 10B illustrates a processing workflow of a diffusion branch 1000B according to an embodiment of the present disclosure. On the sender side, the diffusion branch 1000B is the same as the diffusion branch 1000A in FIG. 10A. On the receiver side, the decoded diffusion latent feature

$${\hat{z}}_{x}^{Diffusion}$$

is fed into a latent transform module 1012. The latent transform module 1012 is configured to compute the embedded latent feature

$${\hat{z}}_{x}^{DM} .$$

In general, the latent transform module 1012 performs enhancement over the decoded diffusion latent feature

$${\hat{z}}_{x}^{Diffusion}$$

by increasing the resolution and feature channel to obtain the embedded latent feature

$${\hat{z}}_{x}^{DM} .$$

In some embodiments, the latent transform module 1012 can be eliminated and the embedded latent feature

$${\hat{z}}_{x}^{DM}$$

is the same as the decoded diffusion latent feature

$${\hat{z}}_{x}^{Diffusion} .$$

Then, similar to FIG. 10A, using either the decoded vision-language latent feature

$${\hat{z}}_{x}^{VL}$$

(corresponding to the workflow of FIG. 6B and FIG. 6D) or the baseline image output \hat{x}ₘₐᵢₙ (corresponding to the workflow of FIG. 6A and FIG. 6C) as a diffusion condition, the reverse diffusion module 1010 is configured to generate the supplement output \hat{x}ₛᵤₚ based on the embedded latent feature

$${\hat{z}}_{x}^{DM} .$$

The reverse diffusion module 1010 in FIG. 10A and FIG. 10B can use any diffusion processes, including a denoising diffusion probabilistic model (DDPM) or a denoising diffusion implicit model (DDIM). The reverse diffusion module 1010 can operate in the pixel domain as the DDPM or in the latent domain as latent diffusion model (LDM). In the case of the DDPM, the embodiment of FIG. 10A is used where the latent embedding module 1008 is skipped. In such a case, the reconstructed image \hat{x}^{DM} is directly fed into the reverse diffusion module 1010 to compute the supplement output \hat{x}ₛᵤₚ.

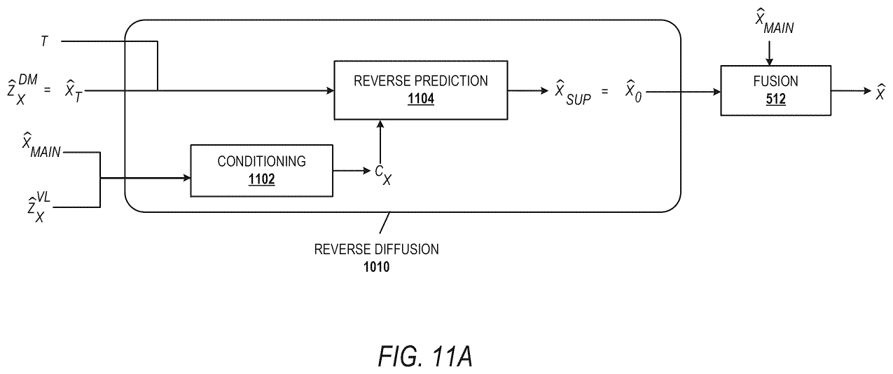

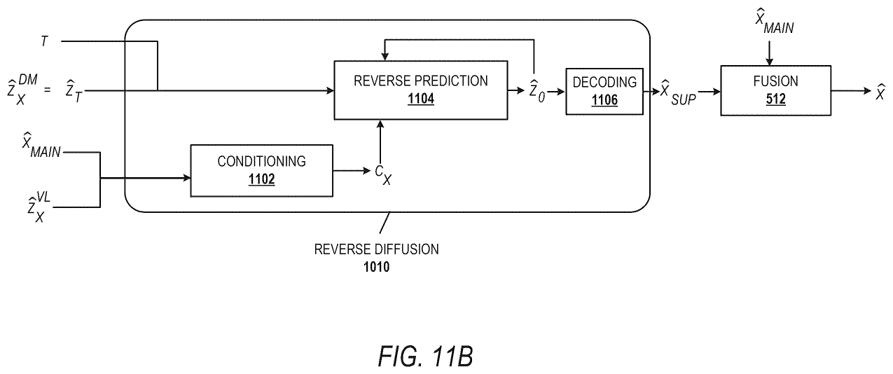

FIG. 11A and FIG. 11B illustrate details of embodiments of the reverse diffusion module 1010 according to the present disclosure. The reverse diffusion module 1010s of FIG. 11A and FIG. 11B are examples of the reverse diffusion module 1010 implemented in FIG. 10A and FIG. 10B that use a CDM for generating supplement image detail. The reverse diffusion module 1010 of FIG. 11A and FIG. 11B include a conditioning module 1102 and a reverse prediction module 1104. The conditioning module 1102, given the decoded vision-language latent feature

$${\hat{z}}_{x}^{VL}$$

(corresponding to the workflow of FIG. 6B and FIG. 6D) or the baseline image output \hat{x}ₘₐᵢₙ (corresponding to the workflow of FIG. 6A and FIG. 6C) as a diffusion condition, is configured to compute a diffusion condition cₓ. In some embodiments, when the baseline image output \hat{x}ₘₐᵢₙ is used as a diffusion condition, the conditioning module 1102 is an embedding network configured to encode the baseline image output \hat{x}ₘₐᵢₙ from the pixel domain into a latent domain (e.g., with the same dimensionality as the embedded latent feature

$${\hat{z}}_{x}^{DM} ) .$$

In some embodiments, when the decoded vision-language latent feature

$${\hat{z}}_{x}^{VL}$$

is used as a diffusion condition, the conditioning module 1102 is a transformation network configured to transform the decoded vision-language latent feature

$${\hat{z}}_{x}^{VL}$$

to the desired dimension (e.g., same as the embedded latent feature

$${\hat{z}}_{x}^{DM} ) .$$

In some embodiments, when the decoded vision-language latent feature

$${\hat{z}}_{x}^{VL}$$

already satisfies the dimension requirement, the transformation network can be skipped. Then the reverse prediction module 1104 is configured to compute, based on the embedded latent feature

$${\hat{z}}_{x}^{DM}$$

and T iterations, either the reverse diffusion step p_{φ}(\hat{x}ₜ₋₁|\hat{x}ₜ, f_{φ}(\hat{x}ₜ, cₓ)) for conditional DDPM or the reverse diffusion step p_{φ}(\hat{z}ₜ₋₁|\hat{z}ₜ, f_{φ}(\hat{z}ₜ, cₓ)) for LDM. Tis an integer greater than 1 (i.e., T≥1). T can be preset, or can be determined for each input x. T can be determined on the receiver side. Alternatively, T can be determined on the sender side and sent to the receiver side together with the diffusion latent feature

$${z}_{x}^{Diffusion} .$$

In some embodiments, the reverse prediction module 1104 can take the original score-based diffusion models using ordinary differential equation (ODE), or the consistency diffusion models based on probability-flow ordinary differential equation (PF-ODE). For DDPM, as shown in FIG. 11A, after T iterations, \hat{x}₀ can directly be used as the supplement output \hat{x}ₛᵤₚ. For LDM, as shown in FIG. 11B, after T iterations, a reverse prediction output 20 is further processed by a decoding network 1106 (e.g., the up sampling part of a UNet) to generate the supplement output \hat{x}ₛᵤₚ. The baseline image output \hat{x}ₘₐᵢₙ from the vision-language branch can be seen as an initial estimate of

$${\hat{x}}_{0}^{init} = {\hat{x}}_{main} ,$$

which is combined with the supplement output \hat{x}ₛᵤₚ from the diffusion branch to generate the final output \hat{x}. In some embodiments, the fusion module 512 simply adds the supplement output \hat{x}ₛᵤₚ and the baseline image output \hat{x}ₘₐᵢₙ (e.g., \hat{x}=\hat{x}ₛᵤₚ+\hat{x}ₘₐᵢₙ). Other interpolation network can be used in the fusion model to further enhance the combination result.

Without loss of generalization, the CDM can be seen as using the vision-language branch to compute a deterministic initial estimate

$${\hat{x}}_{0}^{init} = {\hat{x}}_{main} ,$$

and use this initial estimate (or the latent feature

$${\hat{z}}_{x}^{VL}$$

that generates \hat{x}ₘₐᵢₙ) as conditions to guide the diffusion process to generate the residual details to supplement the baseline image output \hat{x}ₘₐᵢₙ. The CDM reduces the complexity of the diffusion task by switching the target from generating a whole natural image to generating the residual of an image, and provides robustness in controlling the generation process to recover the content of the original image. For the purpose of reducing the generation complexity, a similar CDM has been used for text-to-speech generation.

The different modules in the proposed embodiments can be trained altogether or piece by piece. A module as disclosed herein may be a combination of data, executable instructions, one or more machine learning or AI models, and/or hardware configured to perform a particular function such as those described the present disclosure. The present disclosure does not put any restriction on the network architectures of various modules or the training methods of the modules. For example, in some embodiments, the vision-language branch is first trained with the goal of learning a robust sparse vision-language representation that is highly compressed and can efficiently reconstruct the input image. The vision embedding, reconstruction, text generation, and text embedding module 712 are pre-trained with large scale of datasets containing images with associated text descriptions. Similar to how CLIP or BLIP is trained, the training target is to learn a multi-modal vision-language embedding space that minimizes the distortion of the original and generated image using the embedded feature, minimizing the distortion of the original and generated text description using the embedded feature. Then, the text generation and text embedding module 712 are fixed, and the learnable vision codebook, the vision code generation module 704, the vision feature retrieval module 710 are trained, where the vision embedding and reconstruction module 508 are fine-tuned end-to-end. The training target is to minimize the reconstruction distortion between the original and generate image, and to minimize the codebook matching loss between the embedded vision feature

$${z}_{x}^{V}$$

and un quantized version \hat{z}ₓ. Other loss like the perceptual loss to improve the perceptual quality of the generated image and/or the adversarial GAN loss to improve the naturalism of the generated image can also be used. After being trained, the vision-language branch is fixed, and the diffusion branch is trained. In the training stage, a forward diffusion module 512 is used to add noises iteratively to the embedded latent feature

$${\hat{z}}_{x}^{DM} ,$$

the original input x, or the intermediate latent

$${z}_{x}^{Diffusion} ,$$

and the reverse diffusion module 1010 as well as the fusion module 512, if trainable parameters, are used to combine the supplement output \hat{x}ₛᵤₚ and the baseline image output \hat{x}ₘₐᵢₙ are learned by using the reverse diffusion process to recover the clean signal before the forward diffusion process.

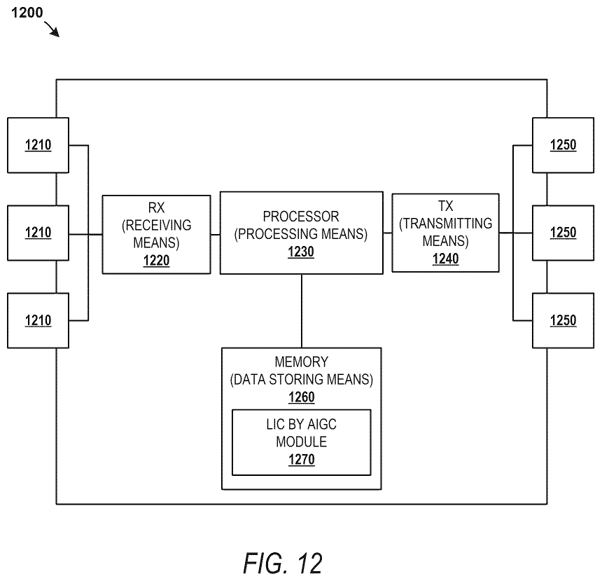

FIG. 12 is a diagram illustrating an apparatus 1200 according to an embodiment of the present disclosure. The apparatus 1200 can be used to implement embodiments of the present disclosure such as, but not limited to, an encoder or a decoder. For example, the apparatus 1200 may be configured to perform the functions of an encoder or a decoder according to any of the embodiments shown in FIG. 5A-FIG. 11B. The apparatus 1200 includes receiver units (RX) 1220 or receiving means for receiving data via ingress ports 1210. The apparatus 1200 also includes transmitter units (TX) 1240 or transmitting means for transmitting via data egress ports 1250. For example, on the sender side, the encoder may use the RX 1220 or receiving means to obtain an original image and/or control instructions, and then use the TX 1240 or transmitting means for transmitting encoded image information (e.g., the vision-language latent feature, diffusion latent feature, and control latent requirement) to the receiver sider. On the receiver side, the decoder may use the RX1220 or receiving means to obtain the encoded image information, and then use the TX or transmitting means for transmitting the decoded image of the original image (e.g., the final output \hat{x}) to a display device or to another computing device.

The apparatus 1200 includes a memory 1260 or data storing means for storing the instructions and various data. The memory 1260 can be any type of, or combination of, memory components capable of storing data and/or instructions. For example, the memory 1260 can include volatile and/or non-volatile memory such as read-only memory (ROM), random access memory (RAM), ternary content-addressable memory (TCAM), and/or static random-access memory (SRAM). The memory 1260 can also include one or more disks, tape drives, and solid-state drives. In some embodiments, the memory 1260 can be used as an over-flow data storage device to store programs when such programs are selected for execution, and to store instructions and data that are read during program execution.

The apparatus 1200 has one or more processors 1230 or other processing means (e.g., central processing unit (CPU)) to process instructions. The one or more processors 1230 may be implemented as one or more CPU chips, cores (e.g., as a multi-core processor), field-programmable gate arrays (FPGAs), application specific integrated circuits (ASICs), and digital signal processors (DSPs). The one or more processors 1230 are communicatively coupled via a system bus with the ingress ports 1210, RX 1220, TX 1240, egress ports 1250, and memory 1260. The one or more processors 1230 can be configured to execute instructions stored in the memory 1260. Thus, the one or more processors 1230 provide a means for performing any computational, comparison, determination, initiation, configuration, or any other action corresponding to the claims when the appropriate instruction is executed by the processor. In some embodiments, the memory 1260 can be memory that is integrated with the processor 1230.

In one embodiment, the memory 1260 stores a LIC by AIGC module 1270. The LIC by AIGC module 1270 includes data, executable instructions, and/or one more sub-modules for implementing the disclosed embodiments. Thus, the inclusion of the LIC by AIGC module 1270 substantially improves the functionality of the apparatus 1200.

Embodiments of the present disclosure provide at least the following technical advantages:

High compression rate with high-quality image generation by using the powerful multi-modal VLM representation through AIGC. The main branch employs a learned sparse vision-language representation that comprises integers and texts. Such a representation is highly efficient for transmission. The VLM models the joint distribution of the sparse codebook-based image representation and the corresponding text descriptions. The VLM is trained over a large scale of image-text data pairs and enables more abundant features from both image and text domains to better describe the input image than using image domain alone. The compression performance is improved compared to previous LIC methods that learn models in image domain solely.

Flexible quality control. The diffusion branch provides supplement fidelity and expressive details extracted from the current input image to improve the reconstruction fidelity to the original input. Such details can be selectively added. The quality of such details can be flexibly adjusted according to practical conditions like computation power, time requirements, quality requirements, and so on. For example, for low computation power with strict time constraint, such details may be skipped to deliver a decompressed output through main branch alone with one inference pass, and the output can be less authentic to the original input. When the target is to deliver a high-quality high-fidelity output and the computation power or time is not a concern, many diffusion iterations can be taken to add rich details to the output.

Flexible task-oriented control through prompts. The control branch uses the prompt VLM that models the multimodal embedded representation between text, images and various forms of prompts to enable guided compression using prompt commands. The control signal can take a default form (e.g., to ensure fidelity or ensure perceptual quality), or can be set to accommodate a specific compression target (e.g., to emphasize on a specific object so that the object can be reconstructed in a certain way). The transmitted control latent requirement can be automatically or manually adjusted to reduce an online loss.

AIGC-guided compression on demand. Due to the highly manipulative nature of prompt inputs like text descriptions, the sender can adjust the text representation

$${z}_{x}^{L}$$

(automatically learned according to some online learning goal or manually adjusted by changing input prompts) to change the generated output based on user demands.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the disclosure is not to be limited to the details given herein. For example, the various elements or components may be combined or integrated in another system or certain features may be omitted, or not implemented. Additionally, the contact plan information may be encoded other types of IPV6 extension headers such as, but not limited to, hop-by-hop options, and other types of routing headers. The present disclosure is intended to cover the carrying of contact plan information and routing information in any of such extension headers.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method implemented by an encoder, comprising:
encoding an original image into a vision-language latent feature comprising text and integers;
computing, based on a control signal and the original image, a control latent requirement indicating an encoded control requirement;
computing, based on the control latent requirement and the vision-language latent feature, a vision-language control latent feature
computing a diffusion latent feature, wherein the diffusion latent feature captures fidelity and expressiveness details of the original image; and
transmitting the vision-language control latent feature, the vision-language latent feature, and the diffusion latent feature to a decoder.

2. The method according to claim 1, wherein computing, based on the control signal and the original image, the control latent requirement comprises:
computing, based on the control signal, a text instruction, wherein the text instruction is a text description describing control requirements of the control signal;
computing, based on the text instruction, the original image, and the control signal, an input-oriented text instruction and additional input-oriented prompt instruction; and
computing, based on the input-oriented text instruction and the additional input-oriented prompt instruction, the control latent requirement.

3. The method according to claim 1, wherein computing the vision-language control latent feature comprises:
computing, based on the vision-language latent feature, a decoded vision-language latent feature;
computing, based on the control latent requirement and the decoded vision-language latent feature, a baseline image output; and
computing, based on the baseline image output and the original image, the vision-language control latent feature.

4. The method according to claim 1, wherein the original image is a general three-dimensional (3D) tensor with shape w×h×c, where w, h, c are a width, a height, and a number of channels of an image, and wherein encoding the original image into the vision-language latent feature comprises:
encoding the original image into a vision feature tensor with shape wₓ×hₓ×d, wherein width wₓ and height hₓ depend on the width and the height of the original image, and wherein d is a number of feature channels;
computing a sparse codebook-based latent feature based on the vision feature tensor and a vision codebook, wherein the vision codebook comprises a plurality of codewords, wherein each codeword has d dimension; and
computing, based on the original image, a language latent feature comprising text words, wherein the vision-language latent feature is a combination of the sparse codebook-based latent feature and the language latent feature.

5. The method according to claim 4, wherein encoding the original image into the vision feature tensor comprises:
dividing, using a visual transformer (ViT), the original image into patches; and
encoding the patches as a sequence.

6. The method according to claim 4, wherein encoding the original image into the vision feature tensor comprises encoding in a parallel manner, using a convolutional neural network (CNN), the original image as an entire image.

7. The method according to claim 4, wherein computing the language latent feature comprises generating, using an image grounded text generator (IGTG), a text description of a content of the original image.

8. The method according to claim 1, wherein computing the diffusion latent feature comprises:
downsampling the original image to smaller resolution images; and
encoding the smaller resolution images to obtain the diffusion latent feature.

9. A method implemented by a decoder, comprising:
receiving a vision-language control latent feature, a vision-language latent feature of an original image, and a diffusion latent feature of the original image, wherein the vision-language latent feature comprises text and integers;
computing, based on the vision-language latent feature, a decoded vision-language feature;
computing, based on the vision-language control latent feature and the decoded vision-language feature, an encoded control feature;
reconstructing, based on the encoded control feature and the decoded vision-language feature, a baseline image output;
computing, based on the diffusion latent feature and the baseline image output, a supplementary output; and
reconstructing, based on the supplementary output and the baseline image output, a final decoded image output.

10. The method according to claim 9, wherein the vision-language latent feature is a combination of a sparse codebook-based latent feature and a language latent feature, wherein the sparse codebook-based latent feature is based on a vision codebook, and wherein computing the decoded vision-language feature comprises:
computing, based on the sparse codebook-based latent feature, using the vision codebook, a decoded image embedding feature;
computing, based on the language latent feature, a text embedding feature; and
combining the text embedding feature and the decoded image embedding feature to obtain the decoded vision-language feature.

11. The method according to claim 9, wherein computing the supplementary output comprises:
recovering, based on the diffusion latent feature, a reconstructed image;
computing an embedded latent feature based on the reconstructed image; and
computing, based on the embedded latent feature and using one of the baseline image output or the vision-language latent feature as a diffusion condition, the supplement output.

12. The method according to claim 9, wherein computing the supplementary output comprises:
computing an embedded latent feature based on the diffusion latent feature; and
computing, based on the embedded latent feature and using one of the baseline image output or the vision-language latent feature as a diffusion condition, the supplement output.

13. The method according to claim 9, wherein computing the supplement output uses a Denoising Diffusion Probabilistic Model (DDPM) or a Denoising Diffusion Implicit Model (DDIM).

14. The method according to claim 11, wherein when the baseline image output is used as the diffusion condition, computing the supplement output comprises encoding, using an embedding network, the baseline image output from a pixel domain to a latent domain.

15. The method according to claim 11, wherein when the vision-language latent feature is used as the diffusion condition, computing the supplement output comprises transforming, using a transformation network, the vision-language latent feature to a dimension corresponding to the embedded latent feature.

16. An encoder, comprising:
a memory configured to store instructions; and
one or more processors coupled to the memory and configured to execute the instructions to cause the encoder to:
encode an original image into a vision-language latent feature comprising text and integers;
compute, based on a control signal and the original image, a control latent requirement indicating an encoded control requirement;
compute, based on the control latent requirement and the vision-language latent feature, a vision-language control latent feature
compute a diffusion latent feature, wherein the diffusion latent feature captures fidelity and expressiveness details of the original image; and
transmit the vision-language control latent feature, the vision-language latent feature, and the diffusion latent feature to a decoder.

17. The encoder according to claim 16, wherein the one or more processors are further configured to execute the instructions to cause the encoder to compute the control latent requirement by:
computing, based on the control signal, a text instruction, wherein the text instruction is a text description describing control requirements of the control signal;
computing, based on the text instruction, the original image, and the control signal, an input-oriented text instruction and additional input-oriented prompt instruction; and
computing, based on the input-oriented text instruction and the additional input-oriented prompt instruction, the control latent requirement.

18. The encoder according to claim 16, wherein the one or more processors are further configured to execute the instructions to cause the encoder to compute the vision-language control latent feature by:
computing, based on the vision-language latent feature, a decoded vision-language latent feature;
computing, based on the control latent requirement and the decoded vision-language latent feature, a baseline image output; and
computing, based on the baseline image output and the original image, the vision-language control latent feature.

19. The encoder according to claim 16, wherein the one or more processors are further configured to execute the instructions to cause the encoder to encode the original image into a vision feature tensor by:
dividing, using a visual transformer (ViT), the original image into patches; and
encoding the patches as a sequence.

20. The encoder according to claim 16, wherein the one or more processors are further configured to execute the instructions to cause the encoder to encode the original image into a vision feature tensor by encoding in a parallel manner, using a convolutional neural network (CNN), the original image as an entire image.
